(19) United States
(12) Patent Application Publication
(10) Pub. No.: US 2026/0029025 A1
(43) Pub. Date: Jan. 29, 2026

(54) BEARING STRUCTURE FOR SPEED REDUCER OF ROBOT, ACTUATOR FOR ROBOT, AND ROBOT

(71) Applicant: Fanuc Corporation, Minamitsuru-gun, Yamanashi (JP)

(72) Inventor: Kazutaka NAKAYAMA, Minamitsuru-gun, Yamanashi (JP)

(73) Assignee: Fanuc Corporation, Minamitsuru-gun, Yamanashi (JP)

(21) Appl. No.: 18/880,632

(22) PCT Filed: Sep. 15, 2022
(86) PCT No.: PCT/JP2022/034610

§ 371 Date: Jan. 2, 2025

(51) Int. Cl. F16C 35/067; B25J 9/10; F16C 17/10; F16C 33/60

(52) U.S. Cl. CPC F16C 35/067; B25J 9/1025; B25J 9/108; F16C 17/10; F16C 33/60; F16C 2322/59; F16C 2361/61

(57) ABSTRACT

Provided are a bearing structure for a speed reducer for a robot, an actuator for a robot, and a robot, wherein the rigidity as an actuator that includes a bearing is equal to that of a cross-roller bearing, and a lubricating oil used in the interior of the speed reducer does not leak to the outside. This bearing structure includes a bearing capable of receiving moment acting in any direction, a plurality of first clamping members for sandwiching an outer ring of the bearing in the axial direction, and a first seal part provided at a location where the plurality of first clamping members oppose one another. At least a portion of the first clamping members is configured from a material having a lower specific gravity than steel.

### CROSS REFERENCE TO RELATED APPLICATIONS

This is the U.S. National Phase application of PCT/JP2022/034610, filed Sep. 15, 2022, the disclosure of this application being incorporated herein by reference in its entirety for all purposes.

### FIELD OF THE INVENTION

The present disclosure relates to a bearing structure for a speed reducer of a robot, an actuator for the robot, and the robot.

### BACKGROUND OF THE INVENTION

A robot can change the position and posture of a work tool by driving a component such as an arm. The robot is provided with a drive unit including an electric motor for moving the component. For example, when the robot has a joint part, the drive unit for moving the component is positioned at the joint part. The drive unit has a power transmission mechanism for transmitting a rotational force from one member to another member.

A power transmission mechanism usually includes a speed reducer for amplifying a torque of a motor. As the speed reducer, a wave gear reducer having a cross roller bearing is well known. Further, technologies for reducing the weight of such a reducer have been proposed (e.g., see Patent Literature 1 and 2).

In addition, since a cross roller bearing has high rotational friction, a technique is well known in which an angular ball bearing is used as the bearing, and aluminum, etc., is used for the components of the bearing to reduce the weight of the bearing (e.g., see Patent Literature 3).

### PATENT LITERATURE

[PTL 1] JP 2019-219041 A

[PTL 2] JP 2020-050242 A

[PTL 3] JP 2010-090942 A

### SUMMARY OF THE INVENTION

Since a cross roller bearing has a compact shape and can withstand a relatively large tilt moment of the arm, the cross roller bearing is often used as a bearing for supporting an output shaft of a speed reducer for the robot. However, a cross roller bearing is heavy and has large rolling friction, so the output efficiency of the speed reducer tends to be low. On the other hand, when using a bearing other than the cross roller bearing, such as an angular ball bearing, it is desirable that the rigidity of an actuator including the bearing is equivalent to that of the cross roller bearing, and that lubricating oil used within the speed reducer does not leak to outside.

One aspect of the present disclosure is a bearing structure for a speed reducer of a robot, the bearing structure comprising: a bearing capable of receiving a moment acting in any direction; a plurality of first clamping members configured to sandwich an outer ring of the bearing in an axial direction; and a first seal part provided at a location where the plurality of first clamping members oppose to each other, wherein at least a portion of the first clamping member is configured from a material having a lower specific gravity than steel.

Another aspect of the present disclosure is an actuator for a robot, comprising: the above bearing structure; and an electric motor for driving an output shaft of the speed reducer.

Still another aspect of the present disclosure is a robot comprising the above bearing structure or the above actuator.

### BRIEF DESCRIPTION OF DRAWINGS

FIG. 1 is a schematic perspective view of a robot according to an embodiment.

FIG. 2 is a schematic cross-sectional view of a bearing structure capable of being applied to the robot of FIG. 1.

FIG. 3 is a schematic radial cross-sectional view of a speed reducer.

FIG. 4 is a partial enlarged view of FIG. 2.

FIG. 5 is a view showing a modification of FIG. 4.

FIG. 6 is a schematic cross-sectional view of a bearing structure according to a comparative example.

### DETAILED DESCRIPTION OF EMBODIMENTS OF THE INVENTION

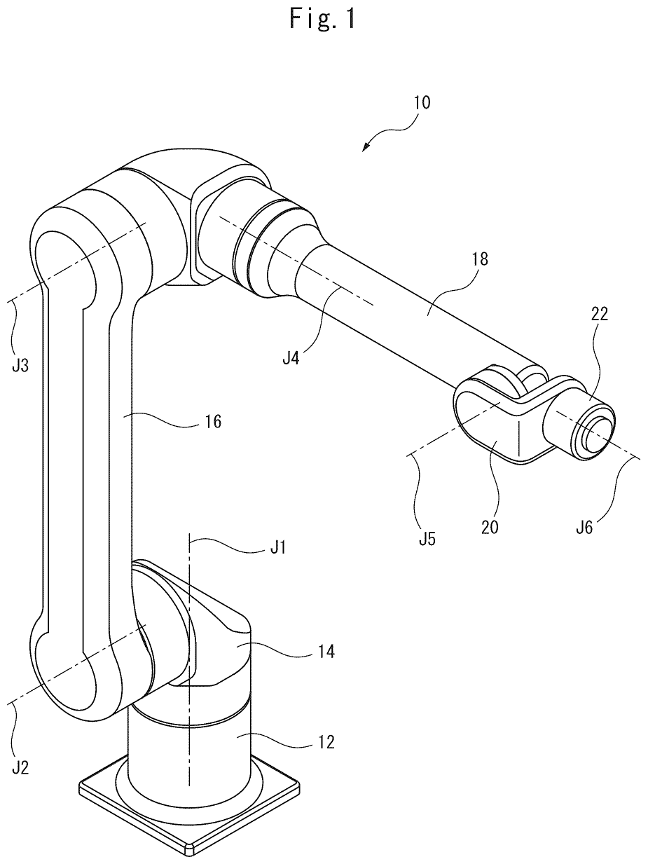

FIG. 1 is a schematic perspective view of a robot 10 according to a preferred embodiment. For example, the robot 10 is an industrial articulated robot, and has a base 12 set fixed to an installation surface such as a floor of a factory, a rotating body 14 attached to the base 12 so as to be rotatable about an axis J1, an upper arm 16 attached to the rotating body 14 so as to be rotatable about an axis J2, a forearm 18 attached to the upper arm 16 so as to be rotatable about an axis J3, a wrist 20 attached to the forearm 18 so as to be rotatable about an axis J4, a flange 22 attached to the wrist 20 so as to be rotatable about an axis J6. The flange 22 is provided with a work tool (not shown) corresponding to an operation to be performed by the robot.

Although the robot 10 according to the embodiment is a vertical articulated robot having six drive axes, the present disclosure is not limited to this, and any robot which can change its position and posture by any mechanism can be used.

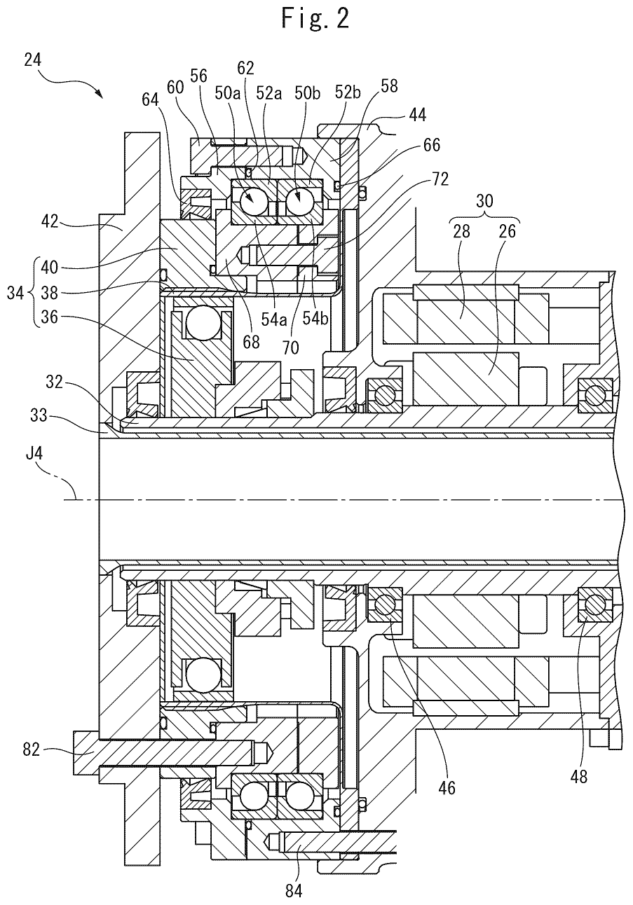

FIG. 2 is a cross-sectional view showing a structural example of a robot actuator 24 including a bearing structure for a speed reducer of the robot 10. Here, a structural example for rotating the forearm 18 about the axis J4 will be described. However, the present example is not limited to this, and can also be applied to a structure around the axis J1, J2, J3, J5, or J6, for example. The actuator 24 is arranged on the side of the forearm 18 opposite to the side on which the wrist 20 is arranged.

The actuator 24 has a bearing structure described below and an electric motor 30 including a rotor 26 and a stator 28, and the rotor 26 is fixed to a shaft 32. The shaft 32 functions as an output shaft of the electric motor 30, and rotates about the axis J4. The shaft 32 is supported by bearings 46, 48 fixed to a housing 44, and a rotational force of the shaft 32 is transmitted to a flange 42 via a speed reducer 34.

A resin protective tube 33 is disposed inside the shaft 32. The protective tube 33 is formed as a cylindrical shape along an inner surface of the shaft 32, and a umbilical member such as an electric wire, an air tube, or an optical communication cable is inserted inside the protective tube 33. The protective tube 33 allows the umbilical member to be disposed inside the joint of the robot 10.

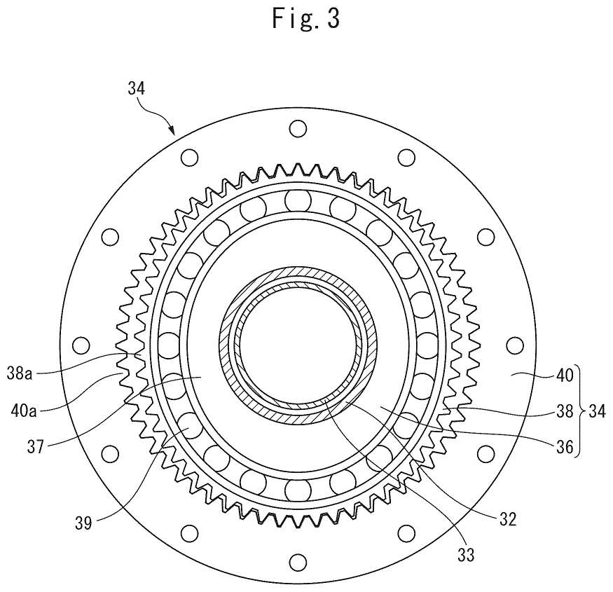

FIG. 3 shows a schematic radial cross section of the speed reducer 34. The speed reducer 34 in the illustrated example is a strain wave gear speed reducer, and has a wave generating member 36 to which a rotational force is input, an elastic cylindrical member 38 arranged radially outside the wave generating member 36, and an annular member (also called a circular spline) 40 arranged radially outside the cylindrical member. The wave generating member 36 includes a hub 37 having an elliptical shape when viewed in the axial direction, and a ball bearing 39 arranged on an outer circumferential surface of the hub. The cylindrical member 38 has teeth 38a on its outer circumferential surface, is configured to elastically deform with the rotation of the hub 37, and is fixed to the housing 44 by a coupling interface such as a bolt 84. The annular member 40 has teeth 40a on its inner circumferential surface that engage with the teeth 38a of the cylindrical member 38, and outputs a rotational force that has been reduced in speed at a reduction ratio according to the number of teeth of the cylindrical member 38 and the number of teeth of the annular member 40.

A main bearing capable of receiving a moment acting in any direction is disposed on the lateral side of the annular member 40. The main bearing in the illustrated example is a combination bearing constituted by two angular ball bearings 50a and 50b adjacent to each other, but a tapered roller bearing, etc., can also be used as the combination bearing. When the ball bearing is used, the rotational friction of the bearing can be reduced compared to a cross roller bearing, etc., and as a result, torque loss due to friction is reduced and output efficiency of the reducer is improved. Also, instead of the combination bearing, a double row bearing or a cross roller bearing without an interface for mounting to other components may be used.

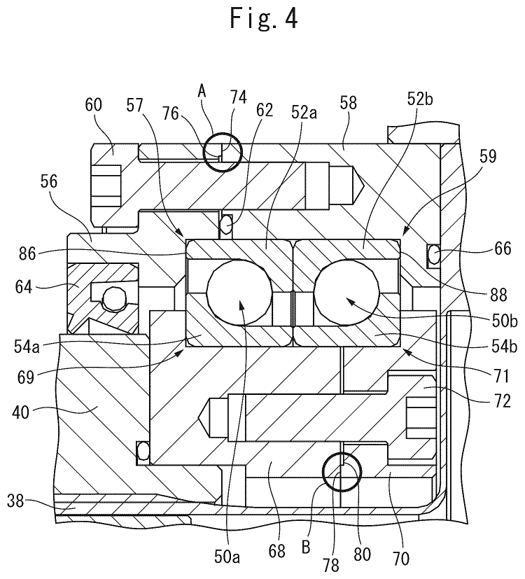

FIG. 4 is a partial enlarged view of around the bearings 50a and 50b. The bearing 50a has an outer ring 52a and an inner ring 54a, and the bearing 50b has an outer ring 52b and an inner ring 54b. The outer rings 52a and 52b are clamped by at least two first clamping members 56 and 58, and the first clamping members 56 and 58 are fastened to each other by a bolt 60 that functions as a clamping function part. Also, the first clamping members 56 and 58 have shoulders 57 and 59 that contact end surfaces of the outer rings 52a and 52b, respectively.

The inner ring 54a of the bearing 50a and the inner ring 54b of the bearing 50b are clamped by at least two second clamping members 68 and 70, that are fastened to each other by a bolt 72 or similar fastening means that functions as a clamping function part. Also, the second clamping members 68 and 70 have shoulders 69 and 71 that contact end surfaces of the inner rings 54a and 54b, respectively. By arranging the shoulders on the second clamping members, a function of aligning the axes of the bearings and the clamping members is necessarily obtained.

At least one of the clamping members 56, 58, 68 and 70 is made of a material having a lower specific gravity than iron or steel. Specific examples of such materials include titanium, aluminum, magnesium, and plastic, etc. By forming the clamping members from a material lighter than iron, the weight of the bearing structure can be reduced, and a speed reducer with high response performance for a power-saving robot can be obtained.

Among the clamping members 56, 58, 68 and 70, with respect to the clamping member 68 on which the circular spline 40 on the inner ring side of the bearing is mounted, deformation of the clamping member 68 will cause deformation of the circular spline 40, which may ultimately be a cause of vibration in the speed reducer. Therefore, it may be preferable to use iron or steel as the material for the clamping member 68, rather than a lightweight material such as aluminum.

Generally speaking, the lighter the bearing structure, the lower its rigidity. Therefore, in the present embodiment, the plurality of clamping members are used to clamp the outer ring or the inner ring of the bearing as described above, and these are fastened using the axial force of the bolt to eliminate or reduce the gap in the axial direction. In addition, since the bearing structure according to the present embodiment is for a robot reducer and has an open type bearing, a seal is provided between the members that contact the outer ring to prevent leakage of lubricating oil, etc., that is filled inside the speed reducer and lubricates the bearing. Hereinafter, a specific example is described.

A part “A” in FIG. 4 shows an example of a canceling mechanism for canceling an axial gap between the axial end surface of the bearing (outer ring) when the outer rings 52a and 52b are clamped and the axial end surface of the clamping member that contacts the axial end surface of the bearing. Specifically, at least one of the clamping members 56 and 58 (the clamping member 56 in this case) has a leg 74 at a portion that contacts the clamping member 58, and the leg 74 contacts the clamping member 58 to form an axial gap 76 between the clamping members 56 and 58. The width of the leg 74, i.e., the radial length (or seating area), is set to a size so that a surface of the clamping member 58 that contacts the leg 74 does not become sunken.

By tightening the bolt 60 from this state, the leg 74 seats on the clamping member 58, and the gap 76 at an unseated portion becomes smaller due to the elastic deformation of the clamping member. This eliminates the axial gap between the bearing end surface and the clamping member end surface that contacts the bearing end surface, generating a frictional force against slipping at the bearing end surface, and the outer ring does not rotate relative to the clamping member. In addition, the bearing itself is clamped in the axial direction and elastically deforms radially outward, so that a frictional force against slipping is also generated on the mating cylindrical surface, suppressing the rotation of the outer ring. By suppressing the rotation in this way, fretting wear on the clamping member side can be avoided.

When the leg 74 is provided, the clamping members 56 and 58 can complete preload adjustment for the bearing alone by tightening the bolt 60 to a specified torque. On the other hand, when the leg 74 is not provided, it is possible to adjust the preload of the bearing itself by the tightening torque of the bolt 60. However, in addition to the fact that dimensional control of the parts becomes complicated and costs increase, care must be taken because the axial force of the bolt becomes low and the bolt 60 may become loose.

A first seal part 62 is provided at a portion where the clamping members 56 and 58 face to each other (more specifically, contact or close to each other), thereby preventing leakage of lubricating oil, etc., used in the speed reducer to the outside. The first seal part 62 is, for example, an O-ring, and is made of an elastically deformable material. When the above-mentioned axial gap becomes smaller due to elastic deformation, the first seal part 62 is crushed, and the first seal part 62 elastically deforms to follow the axial gap. In addition, it is desirable that the first seal part 62 is designed and configured so that it does not generate permanent deformation even in the most crushed state. In terms of the seal structure, the first seal part 62 is preferably arranged in the area between the bearing outer rings 52a, 52b and the clamping bolt 60.

At least a portion of the clamping member 56 that contacts the outer ring 52a is configured to hold a second seal part 64 that seals between the clamping member 56 and the output rotating member (the annular member 40 in this case) of the speed reducer 34. The second seal part 64 is, for example, an oil seal. In addition, by using a low-friction oil seal as the second seal part 64, it is possible to further reduce torque loss in the speed reducer 34 due to rotational friction, and improve the output efficiency of the speed reducer 34.

At least a portion of the clamping member 58 that contacts the outer ring 52b contacts the component of the speed reducer 34 (the cylindrical member 38 in this case), and has a third seal part 66 that seals between the clamping member 58 and the cylindrical member 38 at the contact site. The third seal part 66 is, for example, an elastically deformable O-ring. In terms of the seal structure, the third seal part 66 is preferably disposed at a site of the clamping members 56, 58 that clamp the outer rings 52a, 52b, which protrudes radially inward from a shoulder portion 59 of the member 58 that contacts the reducer 34.

The gap at the inner ring of the bearing can also be canceled by a structure similar to that of the outer ring. A part “B” of FIG. 4 shows an example of a canceling mechanism for canceling an axial gap between the axial end surface of the bearing (inner ring) when the inner rings 54a and 54b are clamped and the axial end surface of the clamping member that contacts the axial end surface of the bearing. Specifically, the clamping member 68 or 70 (the clamping member 70 in this case) has a leg 78 at a portion that contacts the clamping member 68, and the leg 78 contacts the clamping member 68 to form an axial gap 80 between the clamping members 68 and 70. The width of the legs 78, i.e., the radial length (or seating area) is set to a size so that a surface of the clamping member 68 that contacts the leg 78 does not become sunken.

By tightening the bolt 72 from this state, the leg 78 seats on the clamping member 68, and the gap 80 at an unseated portion becomes smaller due to the elastic deformation of the clamping member. This eliminates the axial gap between the bearing end surface and the clamping member end surface that contacts the bearing end surface, generating a frictional force against slipping at the bearing end surface, and the inner ring does not rotate relative to the clamping member. In addition, the bearing itself is clamped in the axial direction and elastically deforms radially outward, so that a frictional force against slipping is also generated on the mating cylindrical surface, suppressing the rotation of the inner ring. By suppressing the rotation in this way, fretting wear on the clamping member side can be avoided.

When the leg 78 is provided, the clamping members 68 and 70 can complete preload adjustment for the bearing alone by tightening the bolt 72 to a specified torque. On the other hand, when the leg 78 is not provided, it is possible to adjust the preload of the bearing itself by the tightening torque of the bolt 72. However, in addition to the fact that dimensional control of the parts becomes complicated and costs increase, care must be taken because the axial force of the bolt becomes low and the bolt 72 may become loose.

As described above, for example, the bolt can be used as the clamping function part that fastens the clamping members for clamping the outer or inner ring of the bearing. However, since the clamping members are made of aluminum, etc., to reduce the weight thereof, it is preferable to use a relatively large number (e.g., 8 to 16) of relatively small bolts (e.g., M4 or smaller) to tighten the clamping members at equal intervals (in the circumferential direction) in order to suppress local deformation of the clamping member. By using a plurality of small bolts, it is also possible to prevent the bolt seat surface from becoming sunken, which is more likely to occur in the case of lightweight materials.

As shown in FIG. 4, a shim 86 may be used as a canceling mechanism for canceling the axial gap between the end surface of the bearing 50a when clamping and the end surface of the clamping member 56 that contacts the end surface of the bearing 50a. Similarly, a shim 88 may be used as a canceling mechanism for canceling the axial gap between the end surface of the bearing 50b when clamping and the end surface of the clamping member 58 that contacts the end surface of the bearing 50b. For example, a plurality of shims with different thicknesses may be prepared in advance, and the axial gap may be measured so that a shim that fills the measured gap may be selected and inserted to eliminate the gap.

The shims 86 and 88 may be made of iron, steel, stainless steel, or copper, etc., and are preferably made of a relatively hard material. However, a wave washer and other structurally elastically deformable materials are not preferable, because they may reduce the rigidity of the bearing structure.

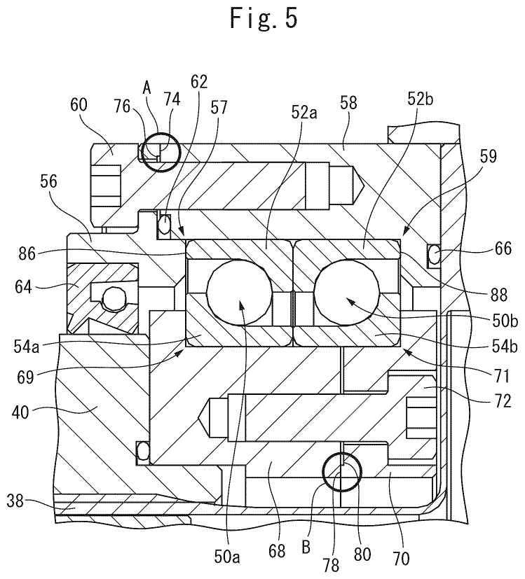

FIG. 5 shows a modification of FIG. 4. The embodiment of FIG. 5 differs from that of FIG. 4 in that the part “A” (i.e., the portion where the first clamping members 56 and 58 are in contact with or close to each other) of FIG. 4 is displaced toward the flange 42 (to the left side) from that of FIG. 4. Specifically, in the example of FIG. 4, the part “A” is located adjacent to the outer ring of the bearing (an outer peripheral surface of the outer ring 52a in this case), whereas in the example of FIG. 5, the part “A” is located toward the flange 42 (opposite the adjacent outer ring 52b) than the axial end surface of the outer ring 52a. The other parts in FIG. 5 may be the same as those in FIG. 4.

Specific embodiments in which the first clamping member is provided with the shoulder that contacts the end surface of the outer ring include an embodiment in which substantially one member 56 has the shoulder 57 as shown in FIG. 4, as well as an embodiment in which the plurality of members 56, 58 cooperate to form the shoulder 57 as shown in FIG. 5. The same can be said for an embodiment in which the second clamping member is provided with a shoulder that contacts the end surface of the inner ring.

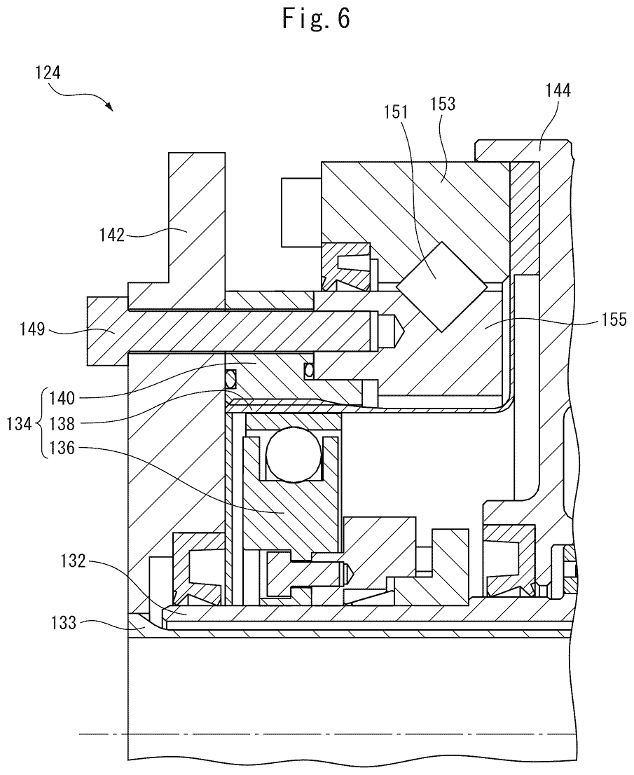

FIG. 6 shows a comparative example in which a cross roller bearing is used as the main bearing. Among the parts shown in FIG. 6, those which may be similar to those shown in FIG. 2 or 4 are given reference numerals obtained by adding 100 to the reference numerals in FIG. 2 or 4, and detailed explanations thereof are omitted.

An actuator 124 as shown in FIG. 6 has a cross roller bearing 151 as a main bearing. The cross roller bearing 151 has an outer ring 153 and an inner ring 155, and the inner ring 155 is fixed to a housing 142 by a fastening means 149 such as a bolt.

In general, a cross roller bearing is often used as a bearing for supporting an output shaft of a robot reducer of a robot, since the cross roller bearing is compact in shape and can withstand a large tilt moment of a robot arm. However, the cross roller bearing is essentially an iron block and has the disadvantage of being heavy. In particular, as shown in FIG. 6, when the outer ring 153 or the inner ring 155 is made large and a fixing interface (bolt 149) for other components is provided thereon, the weight will be even greater.

The above-mentioned strain wave gear speed reducer is widely used in a small robot, and in most cases, a cross roller bearing is used in the strain wave gear speed reducer. Currently, the cross roller bearing accounts for approximately 60% of the weight of the speed reducer. Furthermore, the larger the strain wave gear speed reducer becomes, the more of a bottleneck the weight of the cross roller bearing becomes, and the weight tends to increase rapidly relative to the dimensions of the speed reducer. In addition, the cross roller bearing has high rolling friction, which affects the output efficiency of the speed reducer.

In contrast, in the present embodiment, the plurality of clamping members are used to clamp either or both of the outer ring and the inner ring, and at least one of the clamping members is made of a material lighter than steel, thereby making the bearing structure lighter, and by providing the seal part between the clamping members, the bearing structure that can be used as a speed reducer for a robot is provided.

When comparing the combination of the ball bearing as shown in FIG. 2 with a cross roller bearing in which the outer and inner rings are made of steel, if the bearing part is given the same moment stiffness, then reducing the weight of the clamping member will reduce the stiffness of the lightweight part against the moment compared to steel, resulting in a decrease in the moment stiffness of the actuator as a whole. Therefore, by using the above-mentioned clamping member and gap canceling mechanism to make the moment stiffness of the preload-adjusted bearing part, for example, higher than that of a cross roller bearing, the actuator as a whole can have the same or greater stiffness even when the moment stiffness of the clamping member is reduced.

As shown in FIG. 2, the clamping members 68, 70 that clamp the inner rings 54a, 54b have a coupling interface 82 with another component (the housing 42 in this case) that constitutes the robot 10. Similarly, the clamping members 56, 58 that clamp the outer rings 52a, 52b have a coupling interface 84 with another component (the housing 44 in this case) that constitutes the robot 10. For example, bolts or similar fastening means can be used as the coupling interfaces 82 and 84. Thus, in the present embodiment, the outer ring or inner ring of the bearing is not provided with a coupling interface with other components, and the coupling interface is provided in the clamping member. Therefore, as long as the outer ring and the inner ring are not provided with a coupling interface, it is possible to use a cross roller bearing in the present embodiment as well, and the bearing can be made a cross roller while achieving overall weight reduction.

According to the above-mentioned embodiment, in the bearing structure including the bearing which supports the output shaft of the speed reducer for the robot, the rigidity and sealing property around the bearing can be ensured to function as a bearing, and the output efficiency of the speed reducer can be improved by reducing the weight of the clamping member. Also, the electric motor and the bearing structure for the speed reducer do not necessarily have to be an integrated unit structure (e.g., an actuator unit). For example, the speed reducer, the above-mentioned bearing for the speed reducer, and the electric motor may be directly incorporated in a robot arm formed as a casting.

### REFERENCE SIGNS LIST

10 robot
12 base
14 rotating body
16 upper arm
18 forearm
20 wrist
22 flange
24 actuator
30 electric motor
32 shaft
34 speed reducer
50a, 50b ball bearing
52a, 52b outer ring
54a, 54b inner ring
56, 58 first clamping member
60, 72, 82, 84 bolt
62 first seal part
64 second seal part
66 third seal part
68, 70 second clamping member
74, 78 leg
86, 88 shim
151 cross roller bearing

1. A bearing structure for a speed reducer of a robot, the bearing structure comprising:
a bearing capable of receiving a moment acting in any direction;
a plurality of first clamping members configured to sandwich an outer ring of the bearing in an axial direction; and
a first seal part provided at a location where the plurality of first clamping members oppose to each other,
wherein at least a portion of the first clamping member is configured from a material having a lower specific gravity than steel.

2. The bearing structure according to claim 1, further comprising a plurality of second clamping members configured to sandwich an inner ring of the bearing in an axial direction,
wherein at least a portion of the second clamping member is configured from a material having a lower specific gravity than steel.

3. The bearing structure according to claim 2, wherein the first or second clamping member has a shoulder part which contacts an end surface of the outer ring or the inner ring of the bearing.

4. The bearing structure according to claim 2, wherein at least one of the first or second clamping member has a canceling mechanism configured to cancel an axial gap between an axial end surface of the outer ring or the inner ring and an axial end surface of the clamping member which contacts the axial end surface of the outer ring or the inner ring.

5. The bearing structure according to claim 1, wherein at least a portion of the first clamping member has a second seal part which seals an output rotating member of the speed reducer.

6. The bearing structure according to claim 1, wherein at least a portion of the first clamping member contacts a component of the speed reducer, and has a third seal part which seals between the first clamping member and the component at a contact site therebetween.

7. The bearing structure according to claim 1, wherein the bearing is an open type and is configured to be lubricated by lubrication oil filled inside the speed reducer.

8. The bearing structure according to claim 2, wherein the first or second clamping member has a coupling interface for coupling with another component constituting the robot.

9. The bearing structure according to claim 2, wherein the plurality of first clamping members or the plurality of second clamping members are fastened to each other by a bolt.

10. The bearing structure according to claim 1, wherein the bearing is a paired duplex angular contact ball bearing.

11. The bearing structure according to claim 1, wherein the bearing supports an output shaft of a strain wave gear speed reducer.

12. An actuator for a robot, comprising:
the bearing structure according to claim 1; and
an electric motor for driving an output shaft of the speed reducer.

13. A robot comprising the bearing structure according to claim 1.

14. A robot comprising the actuator according to claim 12.
